(19) United States
(12) Patent Application Publication
(10) Pub. No.: US 2021/0379768 A1
(43) Pub. Date: Dec. 9, 2021

(54) AERIAL NAVIGATION SYSTEM

(71) Applicant: Everseen Limited, Cork (IE)

(72) Inventors: Razvan-Dorel Cioarga, Oradea (RO); Dan Alexandru Pescaru, Timisoara (RO); Cosmin Cernazanu-Glavan, Timisoara (RO); Alan O'Herlihy, Glenville (IE); Joe Allen, Ballybunion (IE)

(21) Appl. No.: 17/336,490

(22) Filed: Jun. 2, 2021

Related U.S. Application Data
(60) Provisional application No. 63/043,816, filed on Jun. 25, 2020.
(60) Provisional application No. 63/034,155, filed on Jun. 3, 2020.
(60) Provisional application No. 63/034,165, filed on Jun. 3, 2020.

(51) Int. Cl. B25J 13/08; G05D 1/00; G06K 9/00

(52) U.S. Cl. CPC B25J 13/089; G05D 1/0088; G05D 2201/0207; G05D 1/0011; G06K 9/0063

(57) ABSTRACT

An aerial navigation system comprises four anchor points mounted on top of four upright members respectively at substantially same height from a ground, a carrier device coupled to a first set of four electric motors mounted at the four anchor points through a set of first wires. The set of first wires, the four upright members and the ground effectively define a volume. The carrier device is moveable in a bounded horizontal plane defined by the four anchor points. A robotic device is suspended from the carrier device using a second wire and moves vertically relative to the carrier device through activation of a fifth electric motor. A control unit is coupled to the first set of four electric motors and the fifth electric motor for controlling the three-dimensional movement of the robotic device to permit navigation from a current location to a target location inside the defined volume.

### CROSS-REFERENCE TO RELATED APPLICATION(S)

This application claims priority to and the benefit of U.S. Provisional Application Ser. No. 63/034,155, filed Jun. 3, 2020, U.S. Provisional Application Ser. No. 63/034,165, filed Jun. 3, 2020, and U.S. Provisional Application Ser. No. 63/043,816, filed Jun. 25, 2020, the entire disclosures of which are hereby incorporated by reference.

### TECHNICAL FIELD

The present disclosure relates generally to an aerial navigation system having an aerial module and a robotic device therein. More specifically, this disclosure relates to a navigation control unit for controlling navigation of the robotic device within a convex quadrilateral volume of the aerial module.

### BACKGROUND

An unmanned aerial vehicle (UAV) (or uncrewed aerial vehicle, commonly known as a drone) is an aircraft without a human pilot on board and a type of unmanned vehicle. UAVs are a component of an unmanned aircraft system (UAS), which include a UAV, a ground-based controller, and a system of communications between the two. The flight of UAVs may operate with various degrees of autonomy, either under remote control by a human operator or autonomously by onboard computers.

Traditional wired robotic devices require manual control of their movements by a trained operator using a joystick apparatus. However, this is an overly labour-intensive process, and requires significant motor skills on the part of the human operator.

### SUMMARY

According to an aspect of the present disclosure, there is provided an aerial navigation system comprising an aerial module having four anchor points mounted on top of four upright members respectively at substantially same height from a ground, a carrier device coupled to a first set of four electric motors mounted at the four anchor points through a set of first wires. The set of first wires, the four upright members and the ground effectively define a volume. The carrier device is moveable in a bounded horizontal plane defined by the four anchor points. The aerial module also has a robotic device coupled to the carrier device through a second wire. The robotic device is adapted to move vertically relative to the carrier device through activation of a fifth electric motor provided in either of the robotic device or the carrier device. The aerial navigation system further comprises a control unit that is coupled to the first set of four electric motors at the four anchor points and the fifth electric motor at either of the robotic device or the carrier device for controlling the three-dimensional movement of the robotic device for permitting navigation of the robotic device from a current location to a target location inside the defined volume.

According to an aspect of the present disclosure, there is provided a method for operating an aerial navigation system to control aerial movement of a robotic device therein. The method includes providing four upright members supported by a ground and mounting top portions of the four upright members with four anchor points respectively at a substantially same height from the ground. The method further includes providing an electric motor from a first set of four electric motors and a wire from a set of first wires to each of the four anchor points to operably support movement of a carrier device in a bounded horizontal plane defined by the four anchor points. The method further includes suspending the robotic device from the carrier device using a second wire such that the robotic device is moveable within a volume defined by the set of first wires, the four upright members and the ground by a fifth electric motor provided at either of the robotic device or the carrier device. The method further includes synchronising operations of the first set of four electric motors at the four anchor points and the fifth electric motor at either of the robotic device or the carrier device to permit the robotic device to be moved from a current location to a target location within the volume.

In yet another aspect, the present disclosure provides a non-transitory computer readable medium having computer-executable instructions stored thereon. These computer-executable instructions when executed by a processor cause the processor to determine a current location of a robotic device within a volume, calculate a route between the current location of the robotic device and a target location based on depth related obstacle information output by a depth detecting sensor, compute parameters including a number of rotation steps (nrot), a direction of rotation (dir), and a speed of rotation (θ) for a first set of four electric motors provided at four anchor points on four upright support members to move a carrier device moveably connected to the first set of four electric motors and a fifth electric motor on either of a robotic device or the carrier device moveably connected to the carrier device, and move the robotic device from a current location to a target location within the volume by synchronising operations of the first set of electric motors provided at the four anchor points and the fifth electric motor on either of the robotic device or the carrier device based, at least in part, on the depth related obstacle information and the computed parameters for each of the electric motors.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates an aerial navigation system having an aerial module showing a plurality of upright members, a carrier device and a robotic device successively connected using wires, and a control unit for controlling movement of the robotic device, in accordance with an embodiment of the present disclosure;

FIG. 2 illustrates a mechanical grabbing claw coupled to the robotic device, in accordance with an embodiment of the present disclosure;

FIG. 3 illustrates a carrier device referential system (CDRS) formed in a bounded horizontal plane of the aerial module, in accordance with an embodiment of the present disclosure;

FIG. 4 illustrates a two dimensional representation of solutions for solving a quadratic equation pertaining to coordinates of the carrier device at a start point, in accordance with an embodiment of the present disclosure;

FIG. 5 illustrates a projection of an exemplary end point in a trajectory of a robotic device in the aerial module, in accordance with an embodiment of the present disclosure; and

FIG. 6 illustrates a method for operating the aerial navigation system to control aerial movement of the robotic device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

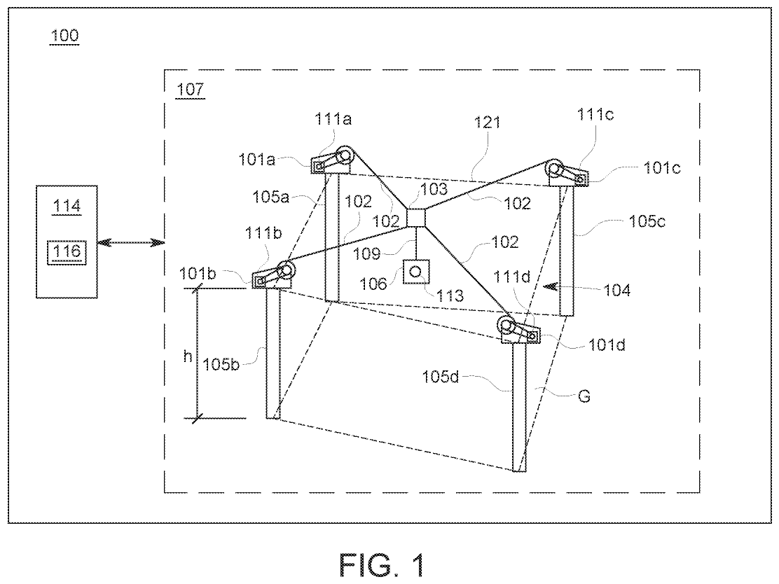

FIG. 1 illustrates an aerial navigation system 100 in accordance with an embodiment of the present disclosure. The aerial navigation system 100 includes an aerial module 107 and a control unit 114. The aerial module 107 comprises four upright members 105a, 105b, 105c and 105d, each of which is supported on a ground surface G. For brevity, the four upright members 105a-150d will hereinafter be collectively referred to as the four upright members and denoted using reference numeral 105. To accomplish adequate support, the four upright members 105 may, at least partly, be driven into the ground G. Examples of structures that can be used to form a upright member 105 may include, but is not limited to, a wall, a pillar, a pole, or a post. Each of four anchor points 101a, 101b, 101c and 101d are mounted on a corresponding upright member 105a, 105b, 105c and 105d at a substantially same height h as from the ground G. For brevity, the four anchor points 101a-101d will hereinafter be collectively referred to as the ‘the anchor points’ and denoted using reference numeral 101.

In embodiments herein, the projection of the anchor points 101 onto the ground G represents the vertices of a convex quadrilateral. Although, the aerial module 107 is shown to include four anchor points 101 mounted on top of four upright members 105, a person skilled in the art will acknowledge that the present disclosure can be similarly applied in cases where, or when, the aerial module 107 includes less than or more than four anchor points as well.

The aerial module 107 includes a carrier device 103 coupled to a first set of four electric motors 111a, 111b, 111c, and 111d mounted at the four anchor points 101 through a set of first wires 102 (hereinafter individually referred to as ‘the first wire’ and denoted using identical numeral ‘102’). In an example, each of these electric motors 111a, 111b, 111c, and 111d may be implemented by use of a direct current (DC) stepper motor. For sake of brevity, the first set of four electric motors 111a-111d will hereinafter be individually referred to as ‘the first electric motor’, or collectively as ‘the first set of electric motors’ or ‘the four electric motors’ and denoted using reference numeral ‘111’). Each of the four electric motors 111 includes a rotor (not shown). Each rotor (not shown) is coupled with a first end of the first wire 102, which is arranged so that the rest of the wire 102 is at least partly wrapped around the rotor. The other end of each wire 102 is coupled with the carrier device 103.

The carrier device 103 is adapted to operably move within a bounded horizontal plane 121 defined by the elevated anchor points 101. This movement is achieved through the activation of the electric motors 111 at the anchor points 101 to cause the first wire 102 coupled to each electric motor 111 to be further wound or unwound from the rotor of the electric motor 111, thereby shortening or lengthening each first wire 102.

The aerial module 107 further includes a robotic device 106 coupled to the carrier device 103 through a second wire 109. Thus, the set of first wires 102, the upright members 105 and the ground G effectively define a volume 104 within which the robotic device 106 resides, or moves.

The robotic device 106 is adapted to move vertically relative to the carrier device 103. This movement is achieved through the activation of a fifth electric motor 113 provided to either of the carrier device 103 or the robotic device 106 to cause the second wire 109 coupled to a rotor of the fifth electric motor 113 to be further wound, or unwound, from the rotor of the fifth electric motor 113, thereby shortening or lengthening the second wire 109. In an example, the fifth electric motor 113 may be implemented by use of a direct current (DC) stepper motor.

A control unit 114 is coupled to the first set of four electric motors 111 at the four anchor points 101 and the fifth electric motor 113 at either of the carrier device 103 or the robotic device 106 for controlling a three-dimensional movement of the robotic device 106 to permit navigation from a current location to a target location inside the defined volume 104. The control unit 114 may be implemented as one or more microprocessors, microcomputers, microcontrollers, digital signal processors, logic circuitries, and/or any devices that manipulate data based on one or more instructional codes. The control unit 114 may be implemented as a combination of hardware and software, for example, programmable instructions that are consistent with implementation of one or more functionalities disclosed herein.

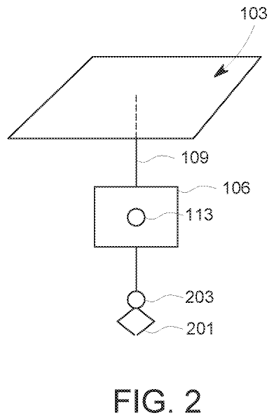

FIG. 2 illustrates the robotic device 106, in accordance with an embodiment of the present disclosure. In this embodiment, the robotic device 106 is equipped, or provided, with a mechanical grabbing claw 201 controlled by a dedicated sixth electric motor 203 in communication with the control unit 114 to allow the mechanical grabbing claw 201 to catch, hold and release a desired payload. In an example, the sixth electric motor 203 may be implemented by use of a direct current (DC) stepper motor.

While FIGS. 1 and 2 show the fifth electric motor 113 housed within the robotic device 106, the skilled person will acknowledge that the embodiment of the present disclosure is not limited to this positioning of the fifth electric motor 113. On the contrary, since the fifth electric motor 113 drives movement of the robotic device 106 relative to the carrier device 103, the skilled person will acknowledge that the fifth electric motor 113 could alternatively be housed within the carrier device 103.

In an embodiment of the present disclosure, the current location of the robotic device 106 is to be determined by the control unit 114. The operations of each of the electric motors 111, 113 at respective ones of the anchor points 101 and the robotic device 106 are synchronized, by the control unit 114 using a shared real-time synchronization interface 116 therein, to allow the robotic device 106 to navigate from the current location and reach the target location within the defined volume 104.

In an embodiment of the present disclosure, to implement navigation of the robotic device 106, the 3D movement of the robotic device 106 is decomposed into movement in two planes to deliver horizontal and vertical movement respectively. The horizontal movement is achieved by moving the carrier device 103 in the bounded horizontal plane 121. The vertical movement is achieved by moving the robotic device 106 in a vertical plane (not shown) perpendicular to the bounded horizontal plane 121. A maximum extent of the vertical plane is bounded between the ground G and the bounded horizontal plane 121, and thereafter, width-wise between the four upright members 105.

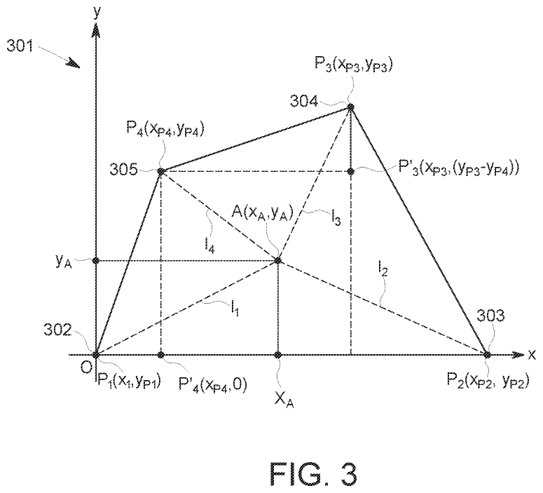

FIG. 3 illustrates the projection of the defined volume 104 onto a carrier device referential system (CDRS) plane 301, in accordance with an embodiment of the present disclosure. The CDRS plane 301 comprises four vertices P₁(x_{P1}, y_{P1}) 302, P₂(x_{P2}, y_{P2}) 303, P₃(x_{P3}, y_{P3}) 304, and P₄(x_{P4}, y_{P4}) 305. These vertices represent the positions of the four anchor points 101 in the aerial module 107.

A current position of the carrier device 103 in the CDRS plane 301 is shown as a point A whose coordinates are (x_{A}, y_{A}). This point A is connected to the vertices P₁, P₂, P₃ and P₄ by line segments of length l₁, l₂, l₃ and l₄ respectively, where these lengths correspond with the lengths of the first wires 102 moveably supporting the carrier device 103.

In an embodiment of the present disclosure, the location of the robotic device 106 within the volume 104 is defined by the following parameters:
(a) the coordinates of the carrier device 103 in the CDRS plane 301; and
(b) the distance between the carrier device 103 and the robotic device 106, denoted by the unwound length of the second wire 109 (thereby representing an extent of penetration of the robotic device 106 from the bounded horizontal plane 121 into the defined volume 104.

The CDRS plane 301 is defined in the bounded horizontal plane 121 and, as shown, has the origin O located in the same point as the first anchor point P₁ 302. A first primary axis (the Ox axis) of the CDRS plane 301 is defined by a line connecting the first anchor point P₁ to a second anchor point P₂. The second primary axis (the Oy axis) of the CDRS plane 301 is defined by a line orthogonally arranged to the Ox axis and intersecting the Ox axis at the origin O.

The first vertex P₁ corresponds to the origin O of the CDRS plane 301. Thus, x_{P1}=0 and y_{P1}=0. From this, it can also be inferred that y_{P2=0}. The remaining coordinates of the second and third vertices P₂ and P₃ are computed based on known distances {d_{P1P2}, d_{P2P3}, d_{P3P4}, d_{P1P4}} between the four anchor points 101. More specifically,

$$\begin{matrix}{x}_{P 2} = {d}_{P 1 P 2} & ( 1 ) \\ {x}_{{p}_{3}} = \frac{{d}_{P 1 P 3}^{2} + {d}_{P 1 P 2}^{2} - {d}_{P 2 P 3}^{2}}{2 {d}_{P 1 P 2}} & ( 2 ) \\ {y}_{{P}_{3}} = \sqrt{{d}_{P 1 P 3}^{2} - {x}_{P 3}^{2}} & ( 3 )\end{matrix}$$

x_{P4} is computed then from the triangles P₁P₄P′₄ (wherein P′₄ is the projection of the P₄ vertex onto the Ox axis of the CDRS plane 301) and P₄P₃P′₃ as follows:

$${x}_{{p}_{4}} = \frac{4 {kx}_{{P}_{3}} \pm \sqrt{16 {k}^{2} {x}_{{P}_{3}}^{2} - 4 ( 4 {x}_{{P}_{3}}^{2} + 4 {y}_{{P}_{3}}^{2} ) ( {k}^{2} - 4 {y}_{{P}_{3}}^{2} {d}_{{P}_{1} {P}_{4}}^{2} )}}{2 ( 4 {x}_{{P}_{3}}^{2} + 4 {y}_{{P}_{3}}^{2} )} , \qquad ( 4 )$$

From:

x_{P}_{₄}²+y_{P}_{₄}²=d_{P}_{₁}_{P}_{₄}², and (5)

(x_{P}_{₃}−x_{P}_{₄})²+(y_{P}_{₃}−y_{P}_{₄})²=d_{P}_{₃}_{P}_{₄}². (6)

y_{P}_{₄}=\sqrt{d_{P}_{₁}_{P}_{₄}²−x_{P}_{₄}²} (7)

x_{P}_{₃}²−2x_{P}_{₃}x_{P}_{₄}+y_{P}_{₃}²−2y_{P}_{₃}\sqrt{d_{P}_{₁}_{P}_{₄}²−x_{P}_{₄}²}+(d_{P}_{₁}_{P}_{₄}²−x_{P}_{₄}²)=d_{P}_{₃}_{P}_{₄}² (8)

x_{P}_{₃}²−2x_{P}_{₃}x_{P}_{₄}+y_{P}_{₃}²−2y_{P}_{₃}\sqrt{d_{P}_{₁}_{P}_{₄}²−x_{P}_{₄}²}+d_{P}_{₁}_{P}_{₄}²=d_{P}_{₃}_{P}_{₄}² (9)

−2(x_{P}_{₃}x_{P}_{₄}+y_{P}_{₃}{square root over (d_{P}_{₁}_{P}_{₄}²−x_{P}_{ᵣ}²))}=−(x_{P}_{₃}²+y_{P}_{₃}²+d_{P}_{₁}_{P}_{₄}²)+d_{P}_{₃}_{P}_{₄}² (10)

Where

k=d_{P}_{₁}_{P}_{₄}²−d_{P}_{₃}_{P}_{₄}²+x_{P}_{₃}²+y_{P}_{₃}² (11)

2y_{P}_{₃}\sqrt{d_{P}_{₁}_{P}_{₄}²−x_{P}_{₄}²}=k−2x_{P}_{₃}x_{P}_{₄} (12)

4y_{P}_{₃}²d_{P}_{₃}_{P}_{₄}²−4y_{P}_{₃}²x_{P}_{₄}²=k²−4kx_{P}_{₃}x_{P}_{₄}+4x_{P}_{₃}²x_{P}_{₄}² (13)

4(x_{P}_{₃}²+y_{P}_{₃}²)x_{P}_{₄}²−4kx_{P}_{₃}x_{P}_{₄}+(k²−4y_{P}_{₃}²d_{P}_{₁}_{P}_{₄}²)=0 (14)

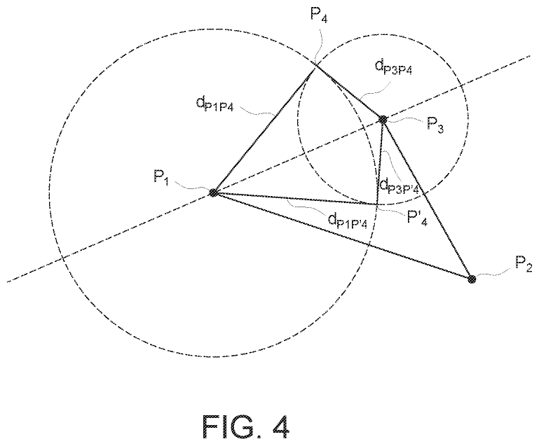

FIG. 4 illustrates a two dimensional representation of solutions for solving the quadratic equation (14) pertaining to the coordinates of the carrier device 103 at its current position i.e., the start point A of the carrier device 103 in the CDRS plane 301, in accordance with an embodiment of the present disclosure. The solutions P₄(x_{P4}, y_{P4}) to the quadratic equation (14) is given by ±x_{P4}. That is, these solutions are symmetrically positioned on either side of the P₁-P₃ line. The two solutions ±x_{P4} form two quadrilaterals, one convex P₁P₂P₃P₄ and one concave P₁P₂P₃P′₄. Of the two solutions, the solution chosen is that which results in the convex quadrilateral, as this would be consistent with the system condition imposed with regards to the positioning of the four upright members 105.

Referring back to FIG. 3, the lengths (l₁ and l₂) of the line segments connecting the point A to the vertices P₁ and P₂ are as follows:

l₁²=x_{A}²+y_{A}² (15)

l₂²=(x_{P2}−x_{A})²+y_{A}² (16)

Combining the two expressions (15) and (16), the coordinates (x_{A}, y_{A}) of the start point A can be established as follows:

$$\begin{matrix}{l}_{1}^{2} - {l}_{2}^{2} = {x}_{A}^{2} - {( {x}_{P 2} - {x}_{A} )}^{2} & ( 17 ) \\ 2 {x}_{A} {x}_{P 2} = ( {l}_{1}^{2} - {l}_{2}^{2} ) + {x}_{P 2}^{2} & ( 18 ) \\ {x}_{A} = \frac{( {l}_{1}^{2} - {l}_{2}^{2} ) + {x}_{P 2}^{2}}{2 {x}_{P 2}} & ( 19 ) \\ {y}_{A} = \sqrt{{l}_{1}^{2} - {x}_{A}^{2}} & ( 20 )\end{matrix}$$

The lengths l₃ and l₄ may be derived in an analogous fashion from the vertices P₃ and P₄.

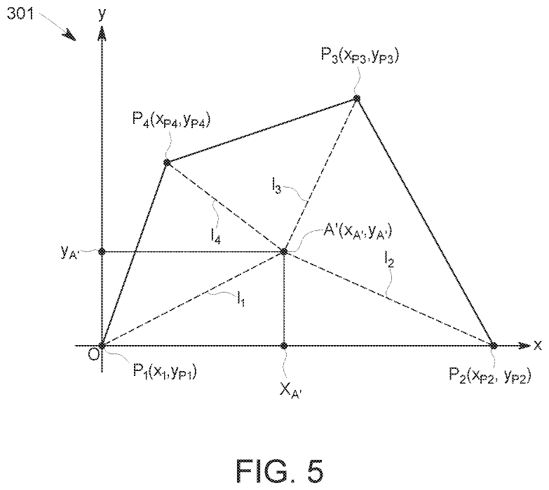

FIG. 5 illustrates the coordinates (x_{A}, y_{A}) of the carrier device 103 at an end point A′, in accordance with an embodiment of the present disclosure.

With combined reference to FIG. 5 and FIG. 1, in an embodiment, the carrier device 103 traverses a navigation route that has an end point A′ within the volume 104. In an analogous fashion to the above derivation of the coordinates (x_{A}, y_{A}) of the current location i.e., start point A of the carrier device 103 explained using the CDRS plane 301 of FIG. 3 and the two dimensional representation in FIG. 4; the coordinates of the end point A′ may also be defined in terms of the changed lengths l′₁, l′₂, l′₃ and l′₄ of the first wires 102 that would be needed to position the carrier device 103 at the location of the end point A′ corresponding to the target location of the robotic device 106. The lengths l′₁, l′₂, l′₃ and l′₄ may be determined using respective ones of the equations (21)-(24) below:

l′₁=\sqrt{x_{A′}²+y_{A′}²} (21)

l′₂=\sqrt{(x_{P}_{₂}−x_{A′})²+y_{A′}²} (22)

l′₃=\sqrt{(x_{P}_{₃}−x_{A′})²+(y_{P}_{₃}−y_{A′})²} (23)

l′₄={square root over ((x_{P}_{₄}−x_{A′}))²+(y_{P}_{₄}−y_{A′})²)} (24)

Referring back to FIG. 1, to move the carrier device 103 from the start point A to the end point A′, the aerial module 107 may include a local computing device (not shown) for facilitating bi-directional communication between the control unit 114 and each electric motor from the four electric motors 111 located at the anchor points 104, the fifth electric motor 113 located at either of the carrier device 103 or the robotic device 106, and the sixth electric motor 203 associated with the mechanical grabber claws 201 (shown in FIG. 2). For instance, the electric motor 111 at the anchor point 104 of each upright member 105 may be provided with a local computing device that controls the rotors of the electric motors 111 located at corresponding ones of the four anchor points 104. Each of the local computing devices may be implemented with a real-time operating system and low-level device drivers to control corresponding ones of the electric motors 111, 113 and 203.

In an embodiment of the present disclosure, the control unit 114 is configured to compute parameters for each electric motor 111 to cause movement of the carrier device 103 along the navigation route, or trajectory, from the start point A to the end point A′ in the CDRS plane 301 as shown in the views of FIGS. 3 and 5 respectively. These parameters are specific for each electric motor i, i∈{1, 2, 3, 4} and represent:
Number of rotation steps (nrotᵢ) needed for an electric motor i to wind/unwind its corresponding first wire 102 by a required length; where the corresponding electric motor 111 acts as a spool with its axle arranged so that it winds/unwinds k cm of wire (e.g., k=0.01 m) with each complete rotation; is given by equation (25) below.

$${nrot}_{i} = \frac{\vert {l}_{i} - {l}_{i}^{′} \vert}{k} \qquad ( 25 )$$

Direction of rotation (dirᵢ): It is hereby envisioned that, in use, the electric motor i winds or unwinds its first wire 102 by the length WO needed to move the carrier device 103 from the start point A to the end point A′ as detailed above. A rotational direction needed by the electric motor i for such winding/unwinding operation is described as +1 for clockwise rotation and −1 for anticlockwise rotation. Accordingly, dirᵢ is computed using equation (26) below.

dirᵢ=sign(lᵢ−l′ᵢ) (26)
Speed of rotation θᵢ: It is hereby further envisioned that in order to move the carrier device 103 from the start point A to the end point A′ within a certain amount of time, all the electric motors 111 must wind/unwind their respective lengths of first wire 102 within the same amount of time. Thus, each electric motor 111 must be capable of operating at a speed that is different from the others. More specifically, to move the carrier device 103 at a predefined speed of ξ m/s (e.g. ξ=0.1 m/s), a rotational speed O of each electric motor (expressed as the number of rotations performed per second) is given by the equations (27) and (28) below.

$${θ}_{i} = \frac{{nrot}_{i}}{{t}_{nav}} \qquad ( 27 )$$

where

$${t}_{nav} = \frac{\sqrt{{( {x}_{{A}^{′}} - {x}_{A} )}^{2} + {( {y}_{{A}^{′}} - {y}_{A} )}^{2}}}{ξ} \qquad ( 28 )$$

Each local computing device may be provided with a buffer. Using the above equations, the control unit 114 may calculate the movement parameters (nrotᵢ, dirᵢ and θᵢ) for each electric motor 111 and communicate the movement parameters for a given electric motor 111 to the local computing device associated therewith. The local computing device may store the movement parameters (nrotᵢ, dirᵢ and θᵢ) in its buffer.

In an embodiment of the present disclosure, synchronisation of movements of all electric motors is achieved through their connection through a real-time synchronization interface such as, for example, with use of an EtherCAT microchip to allow the carrier device 103 to be moved at a pre-defined speed ξ (e.g. ξ=0.1 m/s). The pre-defined speed and direction of travel computed by the control unit 114 for the robotic device 106 may take into account a balance, for instance, between one or more imperatives including, but not limited to, reducing travel time subject to the constraints imposed by the physical limitations of the aerial module 107; or executing smooth starting and stopping of the robotic device 106 whilst ensuring safe movement of the robotic device 106 within the volume of the aerial module 107.

As each local computing device is synchronized through the shared real-time synchronization interface 116 of the control unit 114 to ensure simultaneous yet independent control and operation of the respective electric motors, it is to be understood that the set of first wires 102 moveably connecting each anchor point 101 to the carrier device 103 is maintained taut by mutually optimized speeds, directions and numbers of rotation executed by corresponding ones of the electric motors via the computed parameters (nrotᵢ, dirᵢ and θᵢ). However, it is hereby contemplated that in alternative embodiments of the present disclosure, the set of first wires 101 may not be taut, rather, the carrier device 103 may be partially suspended in relation to the bounded horizontal plane 121 using pre-computed slack willfully, or deliberately, imparted to one or more of the first wires 101, as computed by the control unit 114 depending upon specific requirements of an application.

With execution of a navigation algorithm by the control unit 114, the system's movements are expanded from the bounded horizontal plane 121 to the volume 104, that is, the system movements may be expanded from the CDRS plane 301 to the volume 104. Specifically, the robotic device 106 may be lowered/raised from its current altitude H_{CD} to a target height z_{T} (being the altitude of the robotic device 106 at the target location corresponding to the end point A′ indicated in FIG. 5). This may be achieved using the fifth electric motor 113 that lengthens/shortens the second wire 109 linking the robotic device 106 to the carrier device 103. The movement parameters (nrot_{ARD}, dir_{ARD}, and θ_{ARD}) for the fifth electric motor 113 may be determined using the equations below:

$$\begin{matrix}n r o {t}_{A R D} = \frac{\vert {H}_{C D} - {z}_{T} \vert}{k} & ( 29 ) \\ {dir}_{ARD} = sign ( {H}_{CD} - {z}_{T} ) & ( 30 ) \\ {θ}_{ARD} = \frac{{nrot}_{ARD}}{{t}_{hi \_ lo}} \\ where {t}_{hi \_ lo} is the time taken for the robotic device 106 to traverse the height difference {H}_{CD} - {z}_{T} and is given by equation ( 32 ) below . & ( 31 ) \\ {t}_{hi \_ lo} = \frac{\vert {H}_{CD} - {z}_{T} \vert}{ξ} & ( 32 )\end{matrix}$$

In an embodiment of the present disclosure, equipped with the foregoing formulation, a closed loop control system (including for example, model-based predictive control mechanisms) may be implemented to adapt the parameters for movement of each electric motor from the first set of four electric motors and the fifth electric motor in real time to confirm with curvilinear kinematics. Such adaptation would allow the robotic device 106 to autonomously implement 3D curvilinear trajectories including spiral, conchoid, helical and hemispherical flight paths. Furthermore, the above formulation supports adaptive control of velocity during different stages of the curvilinear trajectory, such that the robotic device 106 accelerates/decelerates to different velocities at different stages of the curvilinear trajectory. These features would enable the aerial module 107 to be implemented for use in enhanced autonomous reconnaissance and surveillance applications. Example use cases may include, but are not limited to, detailed sweep-in views of a surveyed scene, adaptive top down and side-ways views of stacked or tall items (for example, pallets in a warehouse facility), or items partially obscured by one or more obstacles, and tracking of subjects moving in a curvilinear path.

Moreover, referring to FIG. 1, the control unit 114 may further contain a depth detecting sensor, which may include, for example, a radar or an RGB-Depth sensor. In use, the depth detecting sensor may be mounted on the robotic device 106 in a downwards-facing configuration. In particular, the depth detecting sensor may be arranged to detect the presence of one or more items beneath the robotic device 106 and determine the difference in elevation between the robotic device 106 and the detected items. Depending on the elevation of the detected items relative to the robotic device 106, the detected items may be considered potential obstacles by the control unit 114 to the movement of the robotic device 106. Combining a field of view of the depth detecting sensor with the relative elevations of items detected within the field of view, a safe volume may be established along a given trajectory/route by the control unit 114. The safe volume is disposed above, or around a maximum width of, the detected items and is configured to provide a clearance to the movement of the robotic device 106 relative to the detected items. Accordingly, the safe volume may be regarded as a region within which the robotic device 106 may move without risk of collision with items located beneath, or around, the robotic device 106.

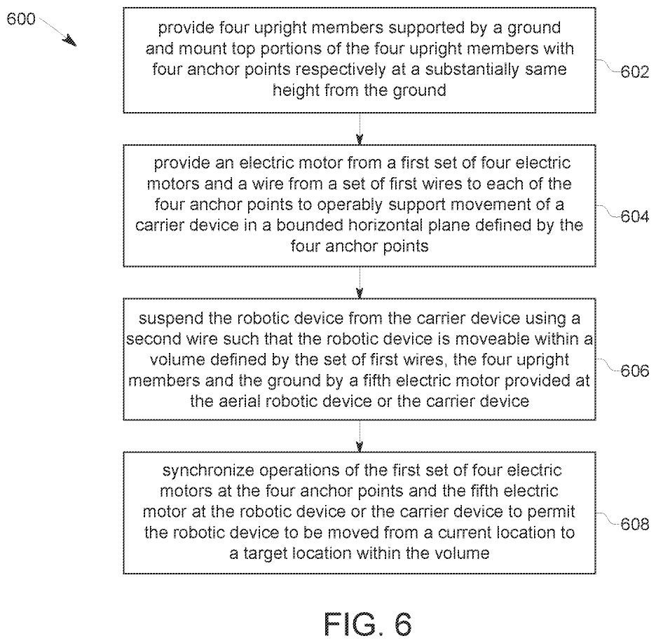

FIG. 6 illustrates a method 600 for operating the aerial navigation system 100, as shown in FIG. 1, to control aerial movement of the robotic device 106, in accordance with an embodiment of the present disclosure.

As shown, at step 602, the method 600 includes providing four upright members 105 supported by the ground G and mounting top portions of the four upright members 105 with the four anchor points 101 respectively at the substantially same height h from the ground G.

At step 604, the method 600 further includes providing an electric motor from the first set of four electric motors 111 and a wire from the set of first wires 102 to each of the four anchor points 101 to operably support movement of the carrier device 103 in the bounded horizontal plane 121 defined by the four anchor points 101.

At step 606, the method 600 further includes suspending the robotic device 106 from the carrier device 103 using the second wire 107 such that the robotic device 106 is moveable within the volume 104 defined between the ground surface G and the bounded horizontal plane 121 by a fifth electric motor 113 of either of the carrier device 103 or the robotic device 106.

At step 608, the method 600 includes synchronising operations of the first set of four electric motors 111 at the four anchor points 101 and the fifth electric motor 113 at either of the carrier device 103 or the robotic device 106 to permit the robotic device 106 to be moved from its current location to the target location within the volume 104.

In an embodiment, the method 600 includes providing the mechanical grabbing claw 201 and the sixth electric motor 203 to the robotic device 106. The mechanical grabbing claw 203 is operated by the sixth electric motor 201 to catch, hold and release the desired payload.

In an embodiment, the method 600 includes computing parameters for each of the four electric motors 111 at respective anchor points 104 to cause movement of the carrier device 103 from the start point A to the end point A′ in the bounded horizontal plane 121 in which the movement of the carrier device 103 is achieved by varying a length of at least three wires 102 from the set of first wires 102. Further, in this embodiment, the method 600 also includes computing parameters for the fifth electric motor 113 at either of the robotic device 106 or the carrier device 106 to cause the robotic device 106 to vertically move from its current altitude H_{CD} to the target height z_{T}. As disclosed earlier herein, the target height z_{T} is the altitude of the robotic device 106 at the target location corresponding to the end point A′ of the carrier device 103 in the bounded horizontal plane 121. The movement of the robotic device 106 is achieved by varying a length of the second wire 109.

In an embodiment, the method 600 includes determining the current location of the robotic device 106 within the volume 104, and calculating a route between the current location and the target location of the robotic device 106. The method 600 further includes calculating, by the control unit 114, the route for the robotic device 106 based, in part, on the computed parameters and the depth related obstacle information output by the depth detecting sensor with the depth detecting sensor being positioned on the robotic device 106.

In an embodiment, the method 600 further includes computing at least three parameters for the movement of the robotic device 106 within the volume 104, and wherein the at least three parameters include the number of rotation steps (nrot), the direction of rotation (dir), and the speed of rotation (θ) for each of the electric motors from the first set of electric motors 111 and the fifth electric motor 113. Further, the method 600 also includes moving the carrier device 103 at a pre-defined speed and direction within the volume 104 by synchronizing individual movements of the electric motors 111 in real-time based on the at least three computed parameters.

It is hereby contemplated that functions consistent with the present disclosure can be embodied as one or more computer-executable software instructions or code that may be stored on a non-transitory computer readable medium. It should be noted that the control unit 114 of the present disclosure may also include one or more processors, micro-processors, controllers, micro-controllers, actuators and the like to individually, or collectively, control operation of the various electric motors in a manner consistent with the present disclosure. These processors, micro-processors, controllers, micro-controllers, actuators and the like may be readily embodied in the form of general purpose computers or application specific controllers that can be readily implemented for use in facilitating operation of the control unit 114 disclosed herein. These software instructions when executed by a processor of the control unit 114 can cause the processor to determine the current location of the robotic device 106 within the volume 104, calculate the route between the current location and the target location of the robotic device 106, and synchronise operations of the electric motors 111, 113 at the anchor points 104 of the upright support members 103 and the carrier device 103 for moving the robotic device 106 from its current location to the target location within the volume 104.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. An aerial navigation system comprising:
an aerial module comprising:
four anchor points mounted on top of four upright members respectively at substantially same height from a ground;
a carrier device coupled to a first set of four electric motors mounted at the four anchor points through a set of first wires, wherein the set of first wires, the four upright members and the ground effectively define a volume, the carrier device moveable in a bounded horizontal plane defined by the four anchor points;
a robotic device coupled to the carrier device through a second wire, wherein the robotic device is adapted to move vertically relative to the carrier device through activation of a fifth electric motor provided in either of the robotic device or the carrier device; and
a control unit coupled to the first set of four electric motors at the four anchor points and the fifth electric motor at either of the robotic device or the carrier device for controlling a three-dimensional movement of the robotic device to permit navigation from a current location to a target location inside the volume.

2. The aerial navigation system of claim 1, wherein a movement of the carrier device within the bounded horizontal plane is achieved through an activation of the first set of four electric motors to cause each of the first wires coupled to corresponding ones of the four electric motors to be further wound or unwound from a rotor of the corresponding ones of the four electric motors, thereby shortening or lengthening respective ones of the first wires.

3. The aerial navigation system of claim 1, wherein the control unit is further configured to compute parameters for:
each of the four electric motors at respective ones of the four anchor points to cause movement of the carrier device from a start point to an end point in the bounded horizontal plane, wherein the movement of the carrier device is achieved by varying a length of at least three wires from the set of first wires; and
the fifth electric motor at either of the robotic device or the carrier device to cause the robotic device to vertically move from a current altitude to a target height, wherein the target height is an altitude of the robotic device at the target location corresponding to the end point of the carrier device in the bounded horizontal plane, wherein the movement of the robotic device is achieved by varying a length of the second wire.

4. The aerial navigation system of claim 3, wherein the computed parameters include a number of rotation steps (nrot), a direction of rotation (dir), and a speed of rotation (0) for each motor from the first set of four electric motors at the anchor points and the fifth electric motor at either of the robotic device or the carrier device respectively.

5. The aerial navigation system of claim 4, wherein the control unit includes a real-time synchronization interface that controls:
movements of the first set of four electric motors independently of one another based on the computed parameters for permitting the carrier device to be moved at a pre-defined speed and direction within the bounded horizontal plane; and
movement of the fifth electric motor to move for permitting the robotic device to be moved at a pre-defined speed within the volume and relative to the carrier device.

6. The aerial navigation system of claim 5 further comprising a mechanical grabbing claw coupled to the robotic device, the mechanical grabbing claw operated by a dedicated sixth electric motor in communication with the control unit to allow the mechanical grabbing claw to catch, hold and release a desired payload.

7. The aerial navigation system of claim 6 further comprising a local computing device provided at each of the four anchor points and the robotic device for facilitating bi-directional communication between the control unit and the first set of electric motors located at the anchor points, the fifth electric motor located at either of the carrier device or the carrier device and sixth electric motor located at the robotic device.

8. The aerial navigation system of claim 1, wherein the control unit is configured to locate the robotic device within the volume using a) coordinates of the carrier device in the bounded horizontal plane, and b) a distance between the carrier device and the robotic device.

9. The aerial navigation system of claim 1, wherein co-ordinates of the carrier device are determined, in part, based on lengths of individual wires from the set of first wires coupling the carrier device to respective ones of the first set of four electric motors at respective ones of the four anchor points.

10. The aerial navigation system of claim 1, wherein a projection of the four anchor points onto the ground represent vertices of a convex quadrilateral representing the defined volume.

11. The aerial navigation system of claim 1, wherein the control unit is further configured to:
determine the current location of the robotic device within the volume; and
calculate a route between the current location and the target location of the robotic device.

12. The aerial navigation system of claim 11, wherein the control unit further comprises a depth detecting sensor positioned on the robotic device, wherein the depth detecting sensor is configured to:
detect one or more obstacles present in the volume; and
determine a difference in elevation between the robotic device and the detected obstacles; and
output depth related obstacle information based on the determined elevation difference for calculating the route between the current location and the target location of the robotic device.

13. A method for operating an aerial navigation system to control aerial movement of a robotic device therein, the method comprising:
providing four upright members supported by a ground and mounting top portions of the four upright members with four anchor points respectively at a substantially same height from the ground;
providing an electric motor from a first set of four electric motors and a wire from a set of first wires to each of the four anchor points to operably support movement of a carrier device in a bounded horizontal plane defined by the four anchor points;
suspending the robotic device from the carrier device using a second wire such that the robotic device is moveable within a volume defined by the set of first wires, the four upright members and the ground by a fifth electric motor provided at either of the robotic device or the carrier device; and
synchronising operations of the first set of four electric motors at the four anchor points and the fifth electric motor at either of the robotic device or the carrier device to permit the robotic device to be moved from a current location to a target location within the volume.

14. The method of claim 13 further comprising moving the carrier device within the bounded horizontal plane through an activation of the first set of four electric motors to cause each of the first wires coupled to corresponding ones of the four electric motors to be further wound or unwound from a rotor of the corresponding ones of the four electric motors, thereby shortening or lengthening respective ones of the first wires.

15. The method of claim 14 further comprising computing parameters for:
each of the four electric motors at respective ones of the four anchor points to cause movement of the carrier device from a start point to an end point in the bounded horizontal plane, wherein the movement of the carrier device is achieved by varying a length of at least three wires from the set of first wires; and
the fifth electric motor at either of the robotic device or the carrier device to cause the robotic device to vertically move from a current altitude to a target height, wherein the target height is an altitude of the robotic device at the target location corresponding to the end point of the carrier device in the bounded horizontal plane, wherein the movement of the robotic device is achieved by varying a length of the second wire.

16. The method of claim 15 further comprising computing at least three parameters for the movement of the robotic device within the volume, and wherein the at least three parameters include a number of rotation steps (nrot), a direction of rotation (dir), and a speed of rotation (θ) for each motor from the first set of four electric motors at the anchor points and the fifth electric motor at either of the robotic device or the carrier device respectively.

17. The method of claim 16 further comprising controlling movements of:
the carrier device at a pre-defined speed and direction within the horizontal plane by synchronizing movements of the first set of four electric motors in real-time based on the at least three computed parameters; and
moving the robotic device at a pre-defined speed within the volume relative to the carrier device by controlling movement of the fifth electric motor based on the at least three computed parameters.

18. The method of claim 13 further comprising providing a mechanical grabbing claw and a dedicated sixth electric motor to the robotic device, wherein the mechanical grabbing claw is operated by the dedicated sixth electric motor to catch, hold and release a desired payload.

19. A non-transitory computer readable medium having stored thereon computer-executable instructions which, when executed by a processor, cause the processor to:
determine a current location of a robotic device within a volume;
calculate a route between the current location of the robotic device and a target location based on depth related obstacle information output by a depth detecting sensor;
compute parameters including a number of rotation steps (nrot), a direction of rotation (dir), and a speed of rotation (θ) for:
a first set of four electric motors provided at four anchor points on four upright support members to move a carrier device moveably connected to the first set of four electric motors; and
a fifth electric motor on either of the carrier device or a robotic device moveably connected to the carrier device; and
move the robotic device from a current location to a target location within the volume by synchronising operations of the first set of electric motors provided at the four anchor points and the fifth electric motor on either of the carrier device or the robotic device based, at least in part, on the depth related obstacle information and the computed parameters for each of the electric motors.
